(19) United States
(12) Patent Application Publication
(10) Pub. No.: US 2025/0277099 A1
(43) Pub. Date: Sep. 4, 2025

(54) SET OF CHEMICALS FOR THE PREPARATION OF A POLYMER

(71) Applicant: Chemische Fabrik Budenheim KG, Budenheim (DE)

(72) Inventors: Thomas FUTTERER, Ingelheim (DE); Sebastian MOSCHEL, Groß-Gerau (DE); Tobias MOSS, Darmstadt (DE); Rüdiger WISSEMBORSKI, Neuruppin (DE)

(73) Assignee: Chemische Fabrik Budenheim KG, Budenheim (DE)

(21) Appl. No.: 18/272,961

(22) PCT Filed: Jan. 18, 2022
(86) PCT No.: PCT/EP2022/051041

§ 371 Date: Jul. 18, 2023

(30) Foreign Application Priority Data
Jan. 19, 2021 (DE) 10 2021 101 065.9

(51) Int. Cl. C08K 3/32; C08G 63/91; C08J 3/24; C09D 7/61; C09D 7/80; C09D 167/04

(52) U.S. Cl. CPC C08K 3/32; C08G 63/91; C08J 3/247; C09D 7/61; C09D 7/80; C09D 167/04; C08K 2003/321; C08K 2003/329

(57) ABSTRACT

A set of chemicals for the preparation of a polymer, a composition containing the set of chemicals, a process for the preparation of a polymer using the set of chemicals, and a polymer obtainable by the process are disclosed. The set of chemicals includes a) one or more polymerisable and/or crosslinkable polymer precursor compounds and one or more metal compounds having one or more metal ions. The one or more metal compounds are b) phosphates, phosphonates, phosphites or mixtures of the foregoing. The weight ratio of a) to b) is in the range of 1000:1 to 2:1.

### OBJECT OF THE INVENTION

The invention relates to a set of chemicals for the preparation of a polymer, a composition containing the set of chemicals, a process for the preparation of a polymer, and a polymer obtainable by said process.

### BACKGROUND OF THE INVENTION

In the prior art, a variety of reaction accelerators for polymerisation and polymer cross-linking reactions are known. At least in the case of reaction accelerators selected from metal compounds with one or more metal ions, the accelerating effect is usually due to the property of the one or more metal ions as a Lewis acidic centre to which the reactive centres of the polymer precursor compounds can coordinate. This influences the polarisation of the polymer precursor compound(s) in such a way that the activation energy of the reaction is reduced and, as a result, the reaction is facilitated or, in many cases, even made possible in the first place.

From DE 2 054 903 A1, for example, a process for the preparation of polyesters by polymerisation of lactones in the presence of antimony pentafluoride or antimony pentachloride as reaction accelerator is known. The aforementioned compounds are added in an amount of 0.001 to 0.5% by weight based on the reaction mixture. However, due to its high reactivity, antimony pentafluoride can only be handled with great care, as it decomposes to hydrogen fluoride and stibane upon contact with other chemicals. Furthermore, antimony pentafluoride is classified as carcinogenic. Since safe use of the polymer obtained is no longer guaranteed, antimony pentafluoride is therefore generally no longer used today to accelerate polymerisation reactions.

WO 2014/139 602 A1 discloses the preparation of a polyester by ring-opening polymerisation of a cyclic polyester oligomer with furan moiety. In the disclosed process, zinc, aluminium or titanium alkoxides or carboxylates are used as reaction accelerators. However, titanium and aluminium alkoxides in particular are highly sensitive to moisture and hydrolyse in water in a rapid exothermic reaction to titanium and aluminium oxides.

US 2006/222 765 A1 relates to a coating composition comprising one or more polymer binders that are crosslinkable. The composition further comprises a reaction accelerator which may be selected from Lewis acids and Lewis bases. Preferred Lewis bases are described as, for example, primary amines or ketimines. However, amines and ketimines often exhibit a yellowish inherent colouration and may therefore affect the optical properties of the polymer obtained. Although the application also describes metal complexes or metal salts as suitable reaction accelerators, specific examples are not mentioned.

### TASK

Against this background, the task of the present invention was to provide a set of chemicals for the preparation of a—preferably cross-linked-polymer, which enables a fast, safe and/or simple preparation of the—preferably cross-linked-polymer. In particular against the background of regulatory provisions, the set of chemicals according to the invention shall furthermore contain only minimal or no amounts of components that may increase the health-hazardous potential of the polymer. In addition, the optical properties of the polymer obtained should not be influenced by the components of the set of chemicals, or only to the smallest possible extent.

### DESCRIPTION OF THE INVENTION

This task is solved according to the invention by a set of chemicals for the preparation of a—preferably crosslinked-polymer, comprising the following components:
a) at least one, i.e. one or more, polymerisable and/or crosslinkable polymer precursor compounds,
b) at least one, i.e. one or more, metal compounds with one or more metal ions, wherein the at least one metal compound is selected from the group consisting of phosphates, phosphonates, phosphites and mixtures of the aforementioned,
wherein
   the weight ratio of a) to b) is in the range from 1000:1 to 2:1, preferably in the range from 1000:1 to 5:1 or 500:1 to 2:1, more preferably in the range from 200:1 to 5:1, even more preferably in the range from 100:1 to 5:1, even more preferably in the range from 50:1 to 5:1 and most preferably in the range from 50:1 to 8:1. Particularly strongly preferred, the weight ratio can also be in the range of 100:1 to 10:1.

### Definitions

If the set of chemicals has several polymerisable and/or several metal compounds, the weight ratio of a) to b) refers in each case to the sum of the compounds according to a) or b). I.e. the total sum of the several compounds according to a) or b) is added and set in relation to the total sum of the respective other component.

By “one or more metal compounds having one or more metal ions” it is understood that the one or more metal compounds may each have one metal ion or several metal ions, i.e. in the case of several metal compounds, for example, one of the metal compounds may have only one metal ion while the other metal compounds have several metal ions. In another case, the multiple metal compounds all have only one metal ion.

According to the invention, “polymer precursor compounds” are understood to be those compounds from which polymers can be obtained by polymerisation and/or polymer crosslinking reactions.

In this context, “polymer” is understood to mean a chemical substance having more than 50% by weight, preferably more than 70% by weight even more preferably more than 80% by weight, even more preferably more than 90% by weight and most preferably more than 95% by weight of macromolecules.

“Macromolecules” are molecules composed of one or more identical or similar structural units, the constitutional repeating units (IUPAC. Compendium of Chemical Terminology, 2nd ed. (the “Gold Book”), A. D. McNaught, A. Wilkinson, Blackwell Scientific Publications, Oxford (1997), S. J. Chalk. ISBN 0-9678550-9-8). Such macromolecules have more than 10 repeating units, preferably more than 15 repeating units. The molar mass is preferably at least 3,000 g/mol, preferably at least 5,000 g/mol, more preferably at least 7,000 g/mol and most preferably at least 10,000 g/mol.

Polymers are usually produced by reacting monomers or oligomers that have one or more of the constitutional repeating units in a polymerisation reaction. In this context, an oligomer is a molecule that has been formed from a plurality of monomers and is therefore composed of a plurality of the structurally same or similar structural units. Oligomers are referred to in the context of the invention when the molecule has been produced from a reaction of 2-10, preferably 2-8, preferably 3-7 monomers.

Both monomers and oligomers are “polymer precursor compounds” within the meaning of the present invention. However, the term “polymer precursor compounds” also includes so-called prepolymers, i.e. chemical substances which contain more than 50% by weight, preferably more than 70% by weight, even more preferably more than 80% by weight, even more preferably more than 90% by weight and most preferably more than 95% by weight of macromolecules which are capable of entering into further polymerisation through reactive groups, whereby they contribute two and more, preferably 10 and more, monomer units to at least one chain of the final macromolecule (IUPAC. Compendium of Chemical Terminology, 2nd ed. (the “Gold Book”), A. D. McNaught and A. Wilkinson, Blackwell Scientific Publications, Oxford (1997), p. J. Chalk. ISBN 0-9678550-9-8).

The set of chemicals according to the invention may comprise one or more polymer precursor compounds. For example, the set of chemicals may comprise a polymer precursor compound that can be converted to a polymer in a ring opening polymerisation. The metal compounds of the invention may accelerate such ring opening due to the Lewis acidic properties of the metal ion. Examples of such polymer precursor compounds are lactones such as ε-caprolactone or lactams.

The set of chemicals according to the invention may also comprise two or more different or identical polymer precursor compounds. For example, the set of chemicals may have two polymer precursor compounds that can be reacted in a condensation reaction to form a polymer. The metal compounds of the invention may accelerate such a condensation reaction due to the Lewis acidic properties of the metal ion. An example of such polymer precursor compounds are polyfunctional acids and alcohols.

Since the molecules according to the invention can also accelerate crosslinking reactions, “polymer precursor compounds” are also understood to mean monomer, oligomer, prepolymer and polymer compounds which can be crosslinked by crosslinking reaction to form a three-dimensional network of macromolecules. Preferably, the cross-linking reaction results in a duromer.

According to the invention, the term “set of chemicals” is understood to mean a predetermined composition of individual chemicals which are either present in separate containers or partially or completely premixed in a composition. Particularly preferably, the set of chemicals is present as a liquid or solid composition.

### Effects/Advantages of the Invention

The inventors have found that the addition of the metal compounds of the invention to a set of chemicals for the preparation of a polymer can significantly accelerate the formation and/or cross-linking of the polymer. Without being bound by this theory, the inventors assume that this is due to the interaction of the metal phosphates with the reactive functional groups of the polymer precursor compounds. Due to the high electron-withdrawing effect of the P—O-containing anions of the metal complexes, the metal ions are strongly positively polarised and can therefore interact particularly effectively with the functional groups of the precursor compounds. Furthermore, the metal compounds according to the invention absorb intensively in the range of UV and IR radiation and can—also due to the particularly pronounced interaction with the functional groups of the precursor compounds—transfer the absorbed energy to the polymer precursor compounds particularly efficiently. The preparation of the polymer can therefore be significantly accelerated by using the set of chemicals according to the invention and/or can be carried out at lower temperatures than with the sets known from the prior art. This effect is particularly pronounced when the set of chemicals is in the form of a liquid or solid composition. Such an embodiment is therefore particularly preferred.

Furthermore, the high polarity of the metal complexes according to the invention enables good miscibility, especially with polar polymer precursor compounds, which usually can only be reacted under difficult conditions, so that these metal complexes are particularly suitable for accelerating the reaction of such compounds. The high polarity also allows the use of the metal compounds according to the invention in polar, often more environmentally compatible solvents such as alcohols or water.

Furthermore, the metal compounds according to the invention have a lower inherent colouration and therefore do not or only insignificantly influence the optical properties of the finished polymer. Particularly preferably, the set of chemicals according to the invention therefore serves for the preparation of a coloured or a coloured polymer.

Furthermore, the metal compounds according to the invention, in particular the phosphates according to the invention, are extremely stable, i.e. they do not require any special handling, for example in an inert gas atmosphere, in order to avoid decomposition or conversion processes. Consequently, they also exhibit an almost constant activity for reaction acceleration over time.

In a preferred embodiment of the invention, the one or more metal ions of the one or more metal compound are selected from the group consisting of alkali metals and alkaline earth metals, the transition metals (d-block, group 3-12), in particular Sc, Y, La, Ti, Zr, Hf, Nb, Ta, Cr, Mo, W, Mn, Cu, Zn, as well as Al, Ga, In, Si, Sn, Sb, Bi.

In a preferred embodiment of the invention, one or more of the metal ions of the metal compound is selected from the group consisting of alkali metals and alkaline earth metals, particularly preferably sodium, potassium and calcium ions. This ensures that the polymer obtained from the set of chemicals according to the invention has only low or no amounts of heavy metals, which are to be avoided or at least reduced in certain applications, in particular due to toxicological and ecological regulations.

In another preferred embodiment of the invention, all of the one or more metal ions of the one or more metal compounds are selected from the group consisting of alkali metals and alkaline earth metals, particularly preferably sodium, potassium and calcium ions.

In a preferred embodiment, one or more metal ions of the metal compound are selected from iron and copper ions. Iron and copper metal compounds according to the invention, in particular iron and copper phosphates, are known in a variety of different modifications. These are ubiquitously available on the market and comparatively inexpensive. Iron and copper phosphates, preferably copper hydroxide phosphate, particularly preferably copper hydroxide phosphate of the empirical formula Cu₂PO₄OH, iron(II) phosphate, preferably in the graftonite structure, are furthermore essentially colourless and are therefore associated with the advantage that they do not or only insignificantly discolour the polymer to be obtained. Moreover, due to their pronounced absorption in the IR and UV range, they facilitate activation of the polymer precursor compounds.

In a further preferred embodiment, all of the one or more metal ions of the metal compound are selected from iron and copper ions. Iron and copper phosphates, preferably copper hydroxide phosphate, particularly preferably copper hydroxide phosphate of the empirical formula Cu₂PO₄OH, iron(II) phosphate, preferably in the graftonite structure, are furthermore essentially colourless and are therefore associated with the advantage that they do not or only insignificantly discolour the polymer to be obtained. Moreover, due to their pronounced absorption in the IR and UV range, they facilitate activation of the polymer precursor compounds.

In a preferred embodiment, the metal compound is a mixed-metal compound that has at least two different metal ions. Mixed-metal compounds are also understood to be metal compounds that have metal ions of only one metal, but where the metal ions are present in different oxidation states.

In a particularly preferred embodiment, the metal compound is a mixed metal compound comprising at least two different metal ions of at least two different metals. Preferably, this mixed-metal compound has at least one alkali metal or alkaline earth metal ion, preferably selected from sodium, potassium and calcium ions, and at least one second transition metal ion, preferably selected from iron and copper ions. Particularly preferred are the compounds potassium copper pyrophosphate, potassium copper phosphate and potassium iron phosphate.

In a preferred embodiment of the invention, the one or more metal compounds are selected from the group consisting of polyphosphates, pyrophosphates, metaphosphates, in particular trimetaphosphates, and mixtures thereof.

In a preferred embodiment of the invention, the one or more metal compounds are selected from the group consisting of mono- and diphosphates. Mono- or diphosphates are readily available synthetically and are therefore widely and inexpensively available on the market.

In another preferred embodiment of the invention, the one or more metal compounds are selected from the group consisting of meta- or polyphosphates. Meta- and polyphosphates have multiple metal ions arranged along the ring or chain structure. This allows multiple metal ions to interact simultaneously with the one or more functional groups of the polymer precursor compound(s). This can result in a stronger activation than by a single metal ion. In addition, the use of meta- or polyphosphates is associated with the advantage that they exhibit good miscibility due to their higher polarity, in particular with polar mono-, oligo- and polymers.

In a further preferred embodiment, the one or more metal compounds are pyrophosphates. Metal pyrophosphates have an even more pronounced polarisation due to the P—O—P acid anhydride bond and are therefore particularly well suited for activating the polymer precursor compounds.

The set of chemicals according to the invention is particularly suitable for the production of thermoplastic and thermoset polymers, especially preferably for the production of duromer plastics from resins, in particular synthetic resins. According to the invention, “resins” are understood to mean prepolymers of duromer plastics (cf. IUPAC. Compendium of Chemical Terminology, 2nd ed. (the “Gold Book”), A. D. McNaught and A. Wilkinson, Blackwell Scientific Publications, Oxford (1997)), which can be used in particular as components of coatings, varnishes and paints. Particularly preferred are these resins obtained by polyaddition or polycondensation, especially polyurethane (PU), polyester, polyamide, urea, melamine, formaldehyde, PVC, acrylic or epoxy resins. The metal compounds according to the invention can be used both for the production of these resins and for the production of duromers from such resins. Due to their high polarity, the metal compounds according to the invention are particularly soluble or dispersible in these resins and can therefore accelerate the conversion of these resins particularly efficiently.

Particularly preferably, the set of chemicals according to the invention is used to obtain a polymer that forms a polymer coating, the polymer coating preferably being a powder coating or a coil coating. In this context, the polymer is particularly preferably a duromer, which is preferably obtained from a resin. The term “polymer coating” is understood to mean a solid mass of a polymer which adheres firmly to the substrate and is spread over an area.

In a preferred embodiment of the invention, the polymer for the preparation of which the set of chemicals according to the invention is suitable is selected from the group consisting of polyvinyl butyral (PVB), polypropylene (PP), polyethylene (PE), polyamide (PA), polyesters such as polybutylene terephthalate (PBT), polyethylene terephthalate (PET), polyurethane (PU), polyurea, urea resins, polyphenylene oxide, polyacetal, polyacrylate, polymethacrylate, polyoxymethylene, polyvinyl acetal, polystyrene, acrylonitrile-butadiene-styrene (ABS), acrylonitrile-styrene-acrylic ester (ASA), polycarbonate, polyethersulfone, polysulfonate, polytetrafluoroethylene, formaldehyde resins, melamine resins, polyetherketone, polyvinyl chloride, polylactide, polysiloxane, phenolic resins, epoxy resins, poly(imide), bismaleimide triazine, thermoplastic polyurethane, ethylene-vinyl acetate copolymer (EVA), copolymers and/or mixtures of the aforementioned polymers, preferably of polyurethane (PU), polyester, urea, melamine or epoxy resin.

Particularly preferably, the set of chemicals according to the invention is suitable for preparing a polymer by polyaddition or polycondensation reaction.

Particularly preferably, the set of chemicals according to the invention is suitable for the production of polyurethanes (PU), polyesters, polyamides, polyureas, PVC, (meth)acrylates or epoxy resins as well as the duromers obtainable therefrom.

In a preferred embodiment of the invention, the set of chemicals according to the invention further comprises an aqueous or organic solvent which is preferably aprotic polar or protic polar. A particular advantage of the metal compounds according to the invention is that, unlike other known reaction accelerators, they have a high polarity and are not very sensitive or even inert to protic compounds and/or oxygen. The set according to the invention can therefore have polar and even protic polar solvents without causing partial or complete alteration or decomposition of the metal compounds. This makes the set of metal compounds according to the invention particularly attractive for such applications where polar solvents such as water are used. The set of chemicals according to the invention is therefore also suitable, for example, for the preparation of water-based polymer coatings.

In a preferred embodiment of the invention, if the set of chemicals includes a solvent, the weight percentage of the solvent in the composition is as high as possible. This allows good heat dissipation during the reaction to prepare the polymer. This is advantageous in order to obtain as uniform a reaction as possible, which favours, for example, a homogeneous molar mass distribution of the polymer. The solvent content by weight is therefore preferably at least 50% by weight, preferably at least 60% by weight, more preferably at least 70% by weight, particularly preferably at least 80% by weight and most preferably at least 90% by weight.

In certain uses of the set of chemicals according to the invention, however, it may be advantageous to use as little solvent as possible, for example if the use of solvents is not possible or only possible to a limited extent due to regulatory provisions. The proportion by weight of solvent in such a preferred embodiment is therefore a maximum of 50% by weight, preferably a maximum of 40% by weight, even more preferably a maximum of 30% by weight, particularly preferably a maximum of 20% by weight and most preferably a maximum of 10% by weight.

The invention also relates to a process for the preparation of a polymer comprising the following steps:
Providing a set of chemicals comprising the following components:
a) one or more polymerisable and/or crosslinkable polymer precursor compounds,
b) one or more metal compounds having one or more metal ions, wherein the metal compound is selected from the group consisting of phosphates, phosphonates, phosphites and mixtures of the foregoing, optional:
c) one or more solvents, preferably selected from aqueous and organic solvents.
   Mixing a) and b) and optionally c) to obtain a composition,
   Reacting the one or more polymer precursor compounds of the composition to obtain the polymer.

In a preferred embodiment of the invention, the composition according to the invention or the polymer obtained therefrom is applied to the surface of an article to form a firmly adherent polymer layer on said article. Such a coating operation is preferably carried out using elevated temperature, i.e. a temperature greater than 40° C., preferably greater than 60° C., more preferably greater than 80° C. and/or under the action of electromagnetic radiation, preferably IR radiation, preferably in a wavelength range of 200-2000 nm, preferably 200 to 1800 nm, even more preferably 300 to 1800 nm, even more preferably 400 to 1800 nm and most preferably 400 to 1500 nm or 800 to 1800 nm.

Provided that the composition of the process according to the invention also comprises a solvent, in a preferred embodiment of the invention the process also comprises removing the solvent from this composition.

In a preferred embodiment of the invention, the mixing of a) and b) and optionally c) is carried out at a temperature of at most 150° C., preferably 120° C., more preferably 100° C. and most preferably 80° C. In this way, it can be avoided that the one or more polymer precursor compounds decompose before reacting or that an unwanted initiation of the reaction occurs.

In a preferred embodiment of the invention, the reaction of the polymer precursor compounds takes place at a temperature of at most 150° C., preferably at most 120° C., particularly preferably at most 100° C. and most preferably at most 80° C. This can prevent the forming polymer from at least partially decomposing and partially losing its desired properties for the application. Furthermore, the increase in viscosity during the polymerisation reaction makes it more difficult to dissipate the heat (Trommsdorff-Norrish effect). Therefore, if the reaction is carried out at elevated temperatures, an exponential increase in the reaction rate may occur during the course of the reaction, resulting in an uncontrolled and uneven reaction.

Insofar as the composition of the process according to the invention comprises a solvent which is removed in an optional process step, the removal of the solvent is preferably carried out at a temperature of at most 150° C., preferably at most 120° C., particularly preferably at most 100° C., and most preferably at most 80° C. This ensures a uniform removal of the solvent and avoids damage to the polymer obtained, for example by “bursting” of the polymer during the removal of entrapped solvent.

To initiate and/or further accelerate the reaction of the polymer precursor compounds, the reaction is preferably carried out at a temperature of at least 50° C., preferably at least 60° C., more preferably at least 70° C. and most preferably at least 80° C.

Insofar as the composition of the process according to the invention comprises a solvent which is removed in a process step, the removal of the solvent preferably takes place at a temperature of at least 50° C., preferably at least 60° C., particularly preferably at least 70° C. and most preferably at least 80° C. This can accelerate the removal of the solvent.

In a preferred embodiment of the invention, the reaction of the composition occurs at a temperature of 50-150° C., preferably a temperature of 50-130° C., more preferably a temperature of 60-120° C., even more preferably a temperature of 60-110° C. and most preferably a temperature of 60-100° C.

In a preferred embodiment of the invention, the removal of the solvent of the composition, if the composition contains a solvent, is carried out at a temperature of 50-150° C., preferably a temperature of 50-130° C., more preferably at a temperature of 60-120° C., even more preferably at 60-110° C. and most preferably at 60-100° C.

The invention also comprises a polymer obtainable by the manufacturing process according to the invention described above.

The set of chemicals according to the invention is particularly suitable for the production of a polymer coating, since the claimed metal compounds have no or only little intrinsic colouring and thus do not or only insignificantly influence the optical properties of the coating obtained. Particularly preferably, such a coating has pigments and/or dyes.

It is also particularly advantageous that the metal compounds according to the invention have a pronounced absorption capacity for IR and UV radiation and can transfer the absorbed thermal radiation particularly efficiently to the precursor compounds in order to accelerate their reaction. In a preferred embodiment of the invention, the metal compounds have a ratio of light absorption at 900 nm wavelength to light absorption at 500 nm wavelength that is in the range of 1:1 to 100:1, preferably in the range of 1.2:1 to 50:1, more preferably in the range of 1.5:1 to 25:1, even more preferably in the range of 2:1 to 10:1, most preferably in the range of 3:1 to 8:1. This effect is particularly pronounced when the reaction of the polymer precursor compounds takes place in aqueous phase.

The invention therefore also relates in particular to the use of a process according to the invention for producing a coating. The “production of a coating” may also comprise the curing of a still deformable coating. Particularly preferably, the production of a coating is carried out under the action of IR radiation, in particular of a wavelength range of 200-2000 nm, preferably 200 to 1800 nm, even more preferably 300 to 1800 nm, even more preferably 400 to 1800 nm and most preferably 400 to 1500 nm or 800 to 1800 nm, in particular for producing a coating for the surface of polymers, composite materials or wood. Preferably, the polymer of such a coating is obtained by polyaddition or polycondensation. Particularly preferably, such a coating is prepared from a resin, in particular a synthetic resin. The polymer obtained is then preferably a thermoplast or a duromer, particularly preferably a duromer. The metal compounds according to the invention absorb markedly in the IR and UV spectral range and transfer the absorbed energy to the precursor compounds and any solvent molecules present, which leads to accelerated curing of a coating.

Exposure to radiation of the above-mentioned wavelength range can accelerate the reaction particularly strongly. Since the location, duration and intensity of the radiation can be controlled very easily and efficiently, such use is particularly preferred.

In a preferred embodiment, the process according to the invention is used to produce a powder coating or a coil coating. Since the metal compounds contained in the polymer have a strong interaction, especially with metallic materials, a stronger bond between the coating and the substrate can be achieved.

The invention also relates to the use of one or more metal compounds with one or more metal ions in a set of chemicals, preferably a composition, for the preparation of a coating, preferably a powder coating or a coil coating, wherein the one or more metal compounds are selected from the group consisting of phosphates, phosphonates, phosphites and mixtures of the foregoing. Particularly preferably, the metal compound is one as defined in claims 1 to 6. Preferably, it is prepared by exposure to electromagnetic radiation of a wavelength range of preferably 200 to 1800 nm, more preferably 300 to 1800 nm, even more preferably 400 to 1800 nm and most preferably 400 to 1500 nm or 800 to 1800 nm. It is particularly preferred to be used in a set of chemicals to prepare a coating for the surface of temperature sensitive materials such as polymers, composites or wood. The one or more metal compounds are preferably selected from the group consisting of polyphosphates, pyrophosphates, metaphosphates, especially trimetaphosphates, or mixtures thereof. The metal ion(s) of the metal compound(s) are preferably selected from the group consisting of alkali metals and alkaline earth metals, the transition metals (d-block, group 3-12), in particular Sc, Y, La, Ti, Zr, Hf, Nb, Ta, Cr, Mo, W, Mn, Cu, Zn, as well as Al, Ga, In, Si, Sn, Sb, Bi. Particularly preferably, the metal ions of the metal compound or compounds are selected from Cu, Fe, Na, K and Ca. Most preferably, the at least one metal compound is an iron or copper phosphate, in particular an iron or copper phosphate selected from the group consisting of potassium copper pyrophosphate, potassium copper phosphate, copper hydroxide phosphate, preferably copper hydroxide phosphate of the empirical formula Cu₂PO₄OH, potassium iron phosphate, iron(II) phosphate, preferably in the graftonite structure, and mixtures of the aforementioned. The coating for the preparation of which the metal compound is used is preferably a polymeric coating, wherein the polymer comprising the polymeric coating at at least 50% by weight, preferably at least 70% by weight, is preferably selected from the list of polymers mentioned in claim 4 and/or is preferably a thermoplastic or a duromer. Particularly preferably, the polymer of the polymer coating is prepared by a polyaddition or polycondensation reaction, preferably from a resin contained in the set of chemicals. Particularly preferably, the polymer is a polyester or an epoxy. The weight percentage of the at least one metal compound in the set of chemicals is preferably at least 0.1 wt %, more preferably at least 0.2 wt %, still more preferably at least 0.5 wt %, still more preferably at least 1 wt %, still considerably more preferably at least 2 wt % and most preferably at least 4 wt %. The weight percentage of the at least one metal compound in the set of chemicals is preferably at most 30% by weight, more preferably at most 25% by weight, even more preferably at most 20% by weight, still more preferably at most 15% by weight and most preferably at most 10% by weight or even at most 8% by weight or at most 5% by weight.

The weight percentage of the at least one metal compound in the set of chemicals is preferably in the range of at least 0.1% by weight to at most 30% by weight, preferably in the range of at least 0.2% by weight to at most 25% by weight, even more preferably in the range of at least 0.5% by weight to at most 20% by weight, even considerably more preferably in the range of at least 1% by weight to at most 20% by weight, and most preferably in the range of at least 2% by weight to at most 15% by weight.

Preferably, the at least one metal compound is used in a set of chemicals for preparing a coating comprising one or more solvents. Particularly preferred is the use of at least one metal compound with one or more metal ions in a set of chemicals for the preparation of a powder coating or a coil coating. Due to the particularly pronounced interaction of the metal compounds with the constituents of the set of chemicals and the advantageous absorption properties, the preparation of the coating can proceed at significantly lower temperatures and/or with shorter preparation times, which is particularly advantageous for temperature-sensitive materials to be coated or for processes with a short coating time (e.g. coil coatings or powder coatings). Particularly preferably, the coating to be prepared with the set of chemicals has pigments and/or dyes.

The invention also relates to the use of one or more metal compounds with one or more metal ions, wherein the one or more metal compounds are selected from the group consisting of phosphates, phosphonates, phosphites and mixtures, preferably of the metal compounds defined in claims 1 to 6, for accelerating a polymerisation and/or crosslinking reaction and/or a drying process, wherein “drying process” is understood to mean the removal of components, in particular solvents, that are volatile at normal conditions (STP) from a composition, preferably a coating.

The invention also relates to the use of one or more metal compounds with one or more metal ions for accelerating the curing and/or drying of a polymer coating, wherein the one or more metal compounds are selected from the group consisting of phosphates, phosphonates, phosphites and mixtures of the aforementioned, preferably from the metal compounds defined in claims 1 to 6, wherein the curing and/or drying is preferably carried out under the action of electromagnetic radiation of a wavelength range of preferably 200 to 1800 nm, even more preferably 300 to 1800 nm, even more preferably 400 to 1800 nm and most preferably 400 to 1500 nm or 800 to 1800 nm. The polymer comprising the polymer coating at least 50% by weight, preferably at least 70% by weight, is preferably selected from the list of polymers mentioned in claim 4 and/or preferably a thermoplast or a duromer. Particularly preferably, the polymer is a polyester or an epoxy. Most preferably, the one or more metal compounds are iron or copper phosphates, in particular iron or copper phosphates selected from the group consisting of potassium copper pyrophosphate, potassium copper phosphate, copper hydroxide phosphate, preferably copper hydroxide phosphate of the empirical formula Cu₂PO₄OH, potassium iron phosphate, iron(II) phosphate, preferably in the graftonite structure, and mixtures of the foregoing. The at least one metal compound is a constituent of the polymer coating and the proportion by weight of the at least one metal compound in the cured and/or dried polymer coating is preferably at least 0.1% by weight, more preferably at least 0.2% by weight, still more preferably at least 0.5% by weight, still more preferably at least 1% by weight, still considerably more preferably at least 2% by weight and most preferably at least 4% by weight. The weight percentage of the metal compound in the cured and/or dried polymer coating is preferably at most 30% by weight, more preferably at most 25% by weight, even more preferably at most 20% by weight, even more preferably at most 15% by weight and most preferably at most 15% by weight or even at most 8% by weight or at most 5% by weight. Preferably, the at least one metal compound is used to accelerate the curing and/or drying of a polymer coating comprising one or more solvents. Particularly preferably, the at least one metal compound is used to accelerate the curing and/or drying of a polymer coating, wherein the polymer coating is a powder coating or a coil coating. Particularly preferred is the use of the one or more metal compounds for curing and/or drying a polymer coating on a temperature sensitive material such as wood, plastic or composite materials. Due to the particularly pronounced interaction of the metal compounds with the constituents of the composition to be cured or dried and the advantageous absorption properties, the curing and/or drying can take place at significantly lower temperatures and/or with shorter curing and/or drying times, which is particularly advantageous for temperature-sensitive materials to be coated or for processes with a short coating time (e.g. coil coatings or powder coatings). Particularly preferably, the polymer coating has pigments and/or dyes.

### EXAMPLES

The invention will now be explained in more detail with reference to specific embodiments.

TABLE 1
Starting materials

| Name | Connection | Manufacturer | Purity | CAS |
|---|---|---|---|---|
| Reafree 8580 | Saturated | Arkema | Acid value: | |
| | carboxylated | | 30-36 mg | |
| | polyester resin | | KOH/g | |
| | | | Glass transition | |
| | | | T_{g}: 61° C. | |
| PPI | Polyester | Neokem Colour | | |
| | powder coating | Performance | | |
| N11-03 | Sodium | Chemische | ≥90% | 13472-35-0 |
| | dihydrogen | Fabrik | | |
| | phosphate | Budenheim KG | | |
| Levall 40 | Sodium | Chemische | ≥90% | 7758-16-9 |
| | pyrophosphate | Fabrik | | |
| | | Budenheim KG | | |
| Fabulase 322 | Copper(II) | Chemische | ≥90% | 12158-74-6 |
| | hydroxide | Fabrik | | |
| | phosphate | Budenheim KG | | |
| KCuPP | Potassium | Chemische | ≥90% | |
| | copper(II) | Fabrik | | |
| | pyrophosphate | Budenheim KG | | |
| KFeP | Potassium iron | Chemische | ≥90% | |
| | (III) phosphate | Fabrik | | |
| | | Budenheim KG | | |

TABLE 2
Networking test

| | Reafree 8580 | Fabulase 322 | Power | Duration | Temp. | |
|---|---|---|---|---|---|---|
| # | [% by weight] | [% by weight] | [Watts] | [sec] | [° C.] | Observation |
| 1 | 100 | 0 | 100 | 540 | 70 | Unmelted, sticky powder, |
| | | | | | | matt appearance |
| 2 | 100 | 0 | 150 | 230 | 75 | Unmelted, sticky powder, |
| | | | | | | matt appearance |
| 3 | 100 | 0 | 150 | 315 | 90 | Partially melted powder, |
| | | | | | | matt appearance |
| 4 | 100 | 0 | 220 | 135 | 110 | Powder completely melted, |
| | | | | | | shiny appearance |
| 5 | 85 | 15 | 100 | 540 | 75 | Partially melted powder, |
| | | | | | | matt appearance |
| 6 | 85 | 15 | 150 | 230 | 96 | Powder completely melted, |
| | | | | | | shiny appearance |

Polyester resin (Reafree 8580, 200 g) is ground to an average particle size of 0.1 mm in an ultracentrifugation mill (manufacturer: Retsch device: ZM200) and compositions are prepared with copper(II) hydroxide phosphate (Fabulase 322) with the weight ratios shown in Table 2. The compositions are finely ground in a coffee grinder, applied to a glass plate and then exposed to IR radiation of the following wavelength (1100 nm). After a given period of time, the surface temperature of the coated plate is determined using an IR thermometer (model: PCE-889B, manufacturer: PCE Instruments). The irradiation time, the irradiation power as well as the maximum temperature obtained in the composition can be found in Table 2.

As can be seen from the comparison of Experiments Nos. 1 and 5 and 2 and 6, the addition of the compound of the invention, fabulase 322, results in a faster conversion of the polymer precursor compound, which can be understood by a higher temperature in the polymer obtained and the formation of an optically uniform coating.

TABLE 3
Solvent frictional resistance test

| | PPI | Levall 40 | Duration | Swabs¹ | | | | |
|---|---|---|---|---|---|---|---|---|
| # | [% by weight] | [% by weight] | [min] | 5 | 10 | 20 | 40 | 80 |
| 7 | 90 | 10 | 10 | — | — | — | — | — |
| 8 | 90 | 10 | 15 | — | — | — | — | — |
| 9 | 85 | 15 | 10 | — | — | — | — | — |
| 10 | 85 | 15 | 15 | — | — | — | — | — |
| | PPI | N11-03 | Duration | Swabs¹ | | | | |
| # | [% by weight] | [% by weight] | [min] | 5 | 10 | 20 | 40 | 80 |
| 11 | 90 | 10 | 10 | — | — | — | — | — |
| 12 | 90 | 10 | 15 | — | — | — | — | — |
| 13 | 85 | 15 | 10 | — | — | — | — | — |
| 14 | 85 | 15 | 15 | — | — | — | — | — |
| | PPI | Fabulase 322 | Duration | Swabs¹ | | | | |
| # | [% by weight] | [% by weight] | [min] | 5 | 10 | 20 | 40 | 80 |
| 15 | 90 | 10 | 10 | — | — | — | — | — |
| 16 | 90 | 10 | 15 | x | x | x | x | x |
| 17 | 85 | 15 | 10 | — | — | — | — | — |
| 18 | 85 | 15 | 15 | x | x | x | x | x |
| | PPI | KCuPP | Duration | Swabs¹ | | | | |
| # | [% by weight] | [% by weight] | [min] | 5 | 10 | 20 | 40 | 80 |
| 19 | 90 | 10 | 10 | — | — | — | — | — |
| 20 | 90 | 10 | 15 | x | x | x | x | — |
| 21 | 85 | 15 | 10 | x | — | — | — | — |
| 22 | 85 | 15 | 15 | x | x | x | x | x |
| | PPI | KFeP | Duration | Swabs¹ | | | | |
| # | [% by weight] | [% by weight] | [min] | 5 | 10 | 20 | 40 | 80 |
| 23 | 90 | 10 | 10 | x | x | — | — | — |
| 24 | 90 | 10 | 15 | x | x | x | x | x |
| 25 | 85 | 15 | 10 | x | x | x | x | — |
| 26 | 85 | 15 | 15 | x | x | x | x | x |

¹— = Test not passed
x = test passed

A polyester powder coating (PPI) is mixed for 30 min in a powder mixer with either sodium dihydrogen phosphate (Levall 40), sodium pyrophosphate (N11-03), copper(II) hydroxide phosphate (Fabulase 322), potassium copper(II) pyrophosphate (KCuPP) or potassium iron(III) phosphate (KFeP) in the ratios given in Table 3. The compositions are then sprayed onto a degreased metal plate using a cup gun (model: PEM-X1 CG, manufacturer: Wagner) and exposed to IR radiation of a wavelength of 1100 nm. After a given period of time, a cotton swab dipped in methyl ethyl ketone is passed over the coated surface with slight pressure. One swipe here corresponds to one upward and one downward movement. After the number of smears shown in table 3, the cotton swab is again soaked in methyl ethyl ketone and the test is repeated. The test is considered passed if the coating cannot be dissolved by the methyl ethyl ketone. The test results can be found in Table 3.

As can be seen from the comparison of experiments 7-14 with experiments 15-26, a stable and solvent-resistant coating is obtained by the addition of the compounds according to the invention.

TABLE 4
Cross-cut test

| | Levall 40 | | N11-03 | | Fabulase 322 | | KCuPP | | KFeP | |
|---|---|---|---|---|---|---|---|---|---|---|
| Duration | 10 | 15 | 10 | 15 | 10 | 15 | 10 | 15 | 10 | 15 |
| [min] | Weight % | wt.-% | wt.-% | wt.-% | wt.-% | wt.-% | wt.-% | wt.-% | wt.-% | wt.-% |
| | ISO 2409 classification | | | | | | | | | |
| 10 | 2 | 1 | 4 | 2 | 2 | 0 | 2 | 3 | 2 | 2 |
| 15 | 2 | 1 | 3 | 2 | 1 | 0 | 1 | 0 | 1 | 0 |
| | ASTM classification | | | | | | | | | |
| 10 | 3B | 4B | 1B | 3B | 3B | 5B | 3B | 2B | 3B | 3B |
| 15 | 3B | 4B | 2B | 3B | 4B | 5B | 4B | 5B | 4B | 5B |

A polyester powder coating (PPI) is mixed with copper(II) hydroxide phosphate (Fabulase 322) for 30 min in a powder mixer in the ratio given in Table 4. The composition is then sprayed onto a degreased metal plate using a cup gun (model: PEM-X1 CG manufacturer: Wagner) and exposed to IR radiation of a wavelength of 1100 nm. The obtained coatings are subjected to a cross-cut test according to DIN EN ISO 2409 with a cross-cut test set (CC3000, manufacturer: TQC). The data show that mechanically resistant coatings are obtained by adding the compounds according to the invention.

### DESCRIPTION OF THE FIGURE

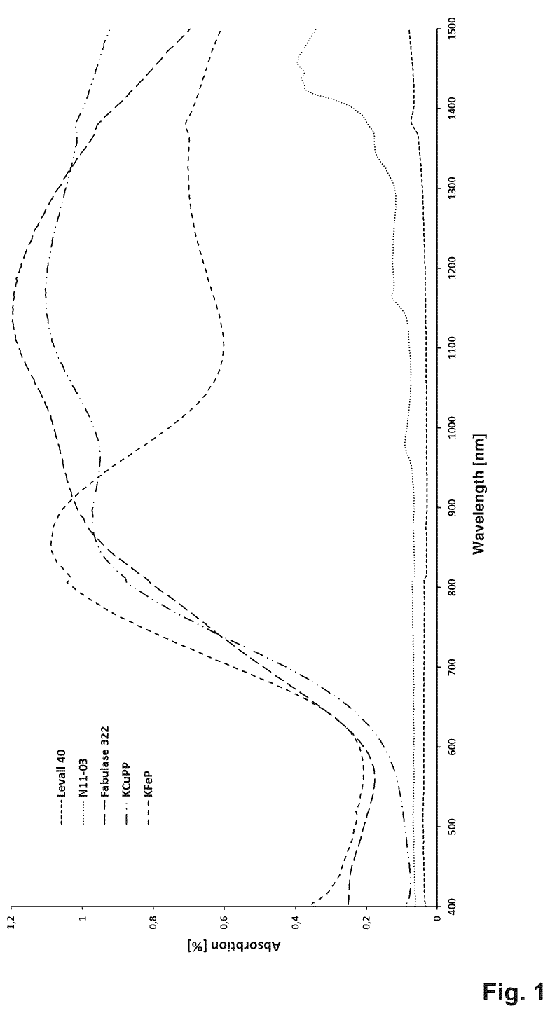

The attached FIG. 1 shows an absorbance measurement of compounds according to the invention in the VIS-IR range, which was recorded with a spectrometer (model: Lambda 950, manufacturer: PerkinElmer). For this purpose, a measuring cuvette made of quartz glass was filled with 1 g sample each and measured by means of an integrating sphere in a measuring range from 400 to 1500 nm and a measuring interval of 3 nm under standard conditions (pressure=1 atm; temperature=25° C.). A tungsten lamp was used as the light source.

1. A set of chemicals for the preparation of a preferably cross-linked polymer comprising the following components:
a) one or more polymerisable and/or crosslinkable polymer precursor compounds,
b) one or more metal compounds having one or more metal ions, wherein preferably the one or more metal ions being transition metal ions, wherein the one or more metal compounds are selected from the group consisting of phosphates, phosphonates, phosphites and mixtures of the foregoing,
characterised in that
the weight ratio of a) to b) is in the range of 1000:1 to 2:1, preferably 100:1 to 5:1.

2. Set of chemicals according to claim 1, wherein the one or more metal ions are selected from the group consisting of alkali and alkaline earth metals, the transition metals (d-block, group 3-12), in particular Sc, Y, La, Ti, Zr, Hf, Nb, Ta, Cr, Mo, W, Mn, Cu, Zn, as well as Al, Ga, In, Si, Sn, Sb, Bi, particularly preferably Na, K, Fe and Cu.

3. Set of chemicals according to any one of the preceding claims, wherein the one or more metal compounds are phosphates, preferably selected from the group consisting of polyphosphates, pyrophosphates, metaphosphates and mixtures thereof.

4. Set of chemicals according to any one of the preceding claims, wherein the polymer is a thermoplast or a duromer, preferably selected from the group consisting of polyvinyl butyral (PVB), polypropylene (PP), polyethylene (PE), polyamide (PA), polyester such as polybutylene terephthalate (PBT), polyethylene terephthalate (PET), polyurethane (PU), polyurea, urea resins, polyphenylene oxide, polyacetal, polyacrylate, polymethacrylate, polyoxymethylene, polyvinyl acetal, polyurea, polystyrene, acrylonitrile butadiene styrene (ABS), acrylonitrile styrene acrylic ester (ASA), polycarbonate, polyether sulfone, polysulfonate, polytetrafluoroethylene, formaldehyde resins, melamine resins, polyether ketone, polyvinyl chloride, polylactide, polysiloxane, phenolic resins, epoxy resins, poly(imide), bismaleimide triazine, thermoplastic polyurethane, ethylene-vinyl acetate copolymer (EVA), copolymers and/or mixtures of the aforementioned polymers, preferably of polyurethane (PU), polyester resins.

5. Set of chemicals according to any one of the preceding claims, wherein the ratio of the light absorption of the one or more metal compounds at 900 nm wavelength to the light absorption at 500 nm wavelength is in the range of 1:1 to 50:1, preferably 3:1 to 8:1.

6. Set of chemicals according to any one of the preceding claims, wherein the set further comprises the following component:
c) one or more solvents, preferably selected from aqueous and organic solvents.

7. A composition comprising the set of chemicals according to any one of the preceding claims, wherein preferably the proportion by weight of c) in the composition is at most 70% by weight, preferably at most 40% by weight, particularly preferably at most 10% by weight.

8. A process for the preparation of a polymer comprising the following steps:
Providing a set of chemicals according to any one of the preceding claims,
Mixing a) and b) and optionally c) to obtain a composition,
Reacting the one or more polymer precursor compounds of the composition to obtain the polymer.

9. Method of claim 8, wherein the composition comprises an aqueous or organic solvent and the method further comprises the following additional step:
Removal of c) from the composition.

10. Process according to any one of the preceding claims, wherein the mixing of a) and b) and optionally c), and/or the reaction and/or the removal of c) from the composition, is carried out at a temperature of at most 150° C., preferably at a temperature of at most 100° C., and preferably under the action of electromagnetic radiation.

11. A polymer obtainable by a process defined in the preceding claims.

12. A coating comprising a polymer according to claim 11, wherein preferably the adhesion classification of the coating determined according to DIN EN ISO 2409 is 0, 1, 2 or 3.

13. Use of one or more metal compounds with one or more metal ions in a set of chemicals for the preparation of a coating, wherein the one or more metal compounds are selected from the group consisting of phosphates, phosphonates, phosphites and mixtures of the foregoing and the coating is preferably prepared under the action of electromagnetic radiation of a wavelength range of 200-2000 nm, preferably 300-1800 nm, more preferably 400-1500 nm.

14. Use according to claim 13 for the production of a powder coating or a coil coating.

15. Use of one or more metal compounds with one or more metal ions for accelerating a polymerisation and/or polymer cross-linking reaction, wherein the one or more metal compounds are selected from the group consisting of phosphates, phosphonates, phosphites and mixtures of the foregoing.

16. Use of one or more metal compounds with one or more metal ions for accelerating the curing and/or drying of a polymer coating, wherein the one or more metal compounds are selected from the group consisting of phosphates, phosphonates, phosphites and mixtures of the foregoing.
